(19) United States
(12) Patent Application Publication
(10) Pub. No.: US 2007/0249336 A1
(43) Pub. Date: Oct. 25, 2007

(54) Telephone system integrated with an electronic device

(75) Inventor: Wei-Hsiang Chi, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: ASUSTeK COMPUTER INC.

(21) Appl. No.: 11/785,373

(22) Filed: Apr. 17, 2007

(30) Foreign Application Priority Data
Apr. 24, 2006 (TW) 095114537

(51) Int. Cl. H04Q 7/20

(52) U.S. Cl. 455/422.1

(57) ABSTRACT

A telephone system integrated with an electronic device includes a mobile end and a base end. The mobile end includes a phone unit for generating voice data, a remote control unit for generating a control signal, and a first wireless communication unit coupled to the phone unit and the remote control unit, for wirelessly transmitting the voice data and a control command according to the control signal. The base end includes a second wireless communication unit for wirelessly receiving the voice data, a network unit coupled to the second wireless communication unit, for transmitting packets of the voice data through a network for establishing a communication connection between the phone unit and a destination, and a control unit coupled to the second wireless communication unit, for receiving the control command outputted from the first wireless communication unit through the second wireless communication unit for controlling the electronic device.

### BACKGROUND OF THE INVENTION

1. Field of the Invention

The present invention provides a telephone system, and more particularly, a telephone system integrated with an electronic device.

2. Description of the Prior Art

As wireless communications technology has been highly developed, a remote control item is broadly used in electronic equipments, telephones, etc., for providing mobile control by wireless communication.

Using a wireless telephone, a user can be free from limitation of a telephone wire to make a phone call unrestrainedly. Similarly, using a remote controller, the user can remotely control household appliances, such as televisions, hi-fi equipments, and air conditioners. However, there is no device combining both the wireless telephone and the remote controller in the prior art.

### SUMMARY OF THE INVENTION

It is therefore a primary objective of the claimed invention to provide a telephone system integrated with an electronic device.

The present invention discloses a telephone system integrated with an electronic device. The telephone system comprises a mobile end and a base end. The mobile end comprises a phone unit for generating voice data, a remote control unit for generating a control signal, and a first wireless communication unit coupled to the phone unit and the remote control unit, for wirelessly transmitting the voice data and a control command according to the control signal. The base end comprises a second wireless communication unit for wirelessly receiving the voice data, a network unit coupled to the second wireless communication unit, for transmitting packets of the voice data through a network for establishing a communication connection between the phone unit and a destination, and a control unit coupled to the second wireless communication unit, for receiving the control command outputted from the first wireless communication unit through the second wireless communication unit for controlling the electronic device.

The present invention further discloses a mobile end of a telephone system integrated with an electronic device. The mobile end comprises a phone unit for generating analog voice data, a remote control unit for generating a control signal, and a wireless communication unit coupled to the phone unit and the remote control unit, for wirelessly transmitting the analog voice data and a control command for controlling the electronic device according to the control signal.

The present invention further discloses a base end of a telephone system integrated with an electronic device. The base end comprises a network unit for transmitting voice data through a network, a wireless communication unit coupled to the network unit for wirelessly receiving the voice data, and a control unit coupled to the wireless communication unit, for receiving a control command through the wireless communication unit for controlling the electronic device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a block diagram of a telephone system integrated with an electronic device in accordance with a preferred embodiment of the present invention.

FIG. 2 illustrates a schematic diagram of a phone unit.

### DETAILED DESCRIPTION

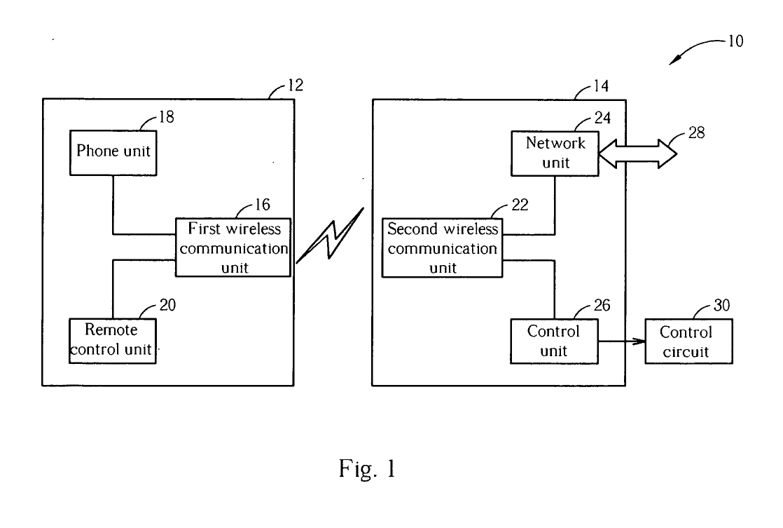

Please refer to FIG. 1, which illustrates a block diagram of a telephone system 10 integrated with an electronic device in accordance with a preferred embodiment of the present invention. The telephone system 10 includes a mobile end 12 and a base end 14. The base end 14 is installed inside an electronic device, which can be a TV, hi-fi equipment, computer system, or other devices having remote controllers. The base end 14 includes a second wireless communication unit 22, a network unit 24, and a control unit 26. The mobile end 12 includes a first wireless communication unit 16, a phone unit 18, and a remote control unit 20.

In the mobile end 12, the phone unit 18 performs voice communication, and the remote control unit 20 controls the electronic device. The phone unit 18 and the remote control unit 20 are electrically connected to the first wireless communication unit 16. The first wireless communication unit 16 exchanges signals with the second wireless communication unit 22 of the base end 14 through a wireless communication channel. In the base end 14, the network unit 24 and the control unit 26 are electrically connected to the second wireless communication unit 22, the network unit 24 can establish a communication connection between the phone unit 18 and a destination through a extranet 28 according information data of a receiver received by the phone unit 18, and the control unit 26 controls a control circuit 30 of the electronic device for adjusting operations of the electronic device according to commands received by the remote control unit 20.

In other words, when a user makes a phone call by the telephone system 10, the phone unit 18 establishes a communication connection through the first wireless communication unit 16, the second wireless communication unit 22, the network unit 24, and the extranet 28 to a destination. Oppositely, an incoming phone call trigger rings of the phone unit 18 through the network unit 24, the second wireless communication unit 22, and the first wireless communication unit 16.

Moreover, according to control signals (such as channel or volume up/down) inputted by the user, the remote control unit 20 of the mobile end 12 outputs commands to the control unit 26 through the first wireless communication unit 16 and the second wireless communication unit 22, so as to adjust operations of the control circuit 30.

Notice that, the telephone system 10 shown in FIG. 1 is an exemplarily embodiment of the present invention, and those skilled in the art can make alternations accordingly.

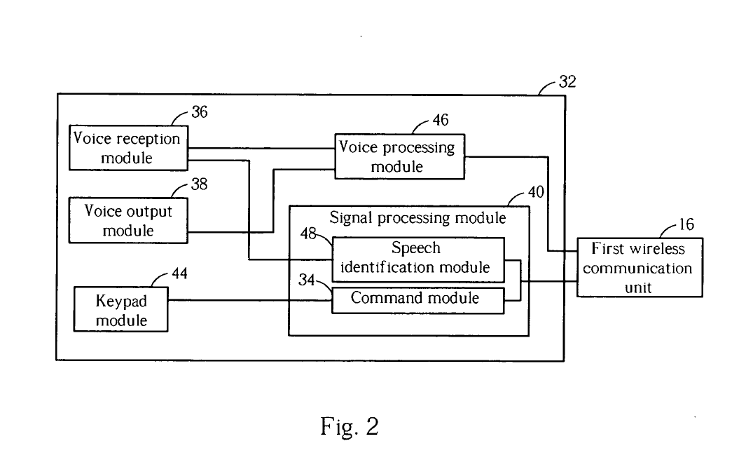

Please refer to FIG. 2, which illustrates a schematic diagram of a phone unit 32. The phone unit 32 can be utilized for implementing the phone unit 18 shown in FIG. 1, and includes a voice reception module 36, a voice output module 38, a signal processing module 40, a keypad module 44, and a voice processing module 46. The signal processing module 40 includes a command module 34 and a speech identification module 48. The command module 34 is electrically connected to the first wireless communication unit 16, and utilized for receiving identification data (such as telephone number and IP address) of a receiver inputted by a user through the keypad module 44, and for receiving control commands (such as voice command data) through the voice reception module 36, so as to control a system and devices coupled to the system, such as digital household appliances. The first wireless communication unit 16 can wirelessly transmit the identification data of the receiver and the control commands to the network unit 24. The speech identification module can receive a phone number or IP address through the voice reception module 36, and wirelessly transmit the identification data to the second wireless communication unit 22 through the first wireless communication unit 16, so as to demand the phone unit 32 for a communication connection with the destination.

The voice reception module 36 and the voice output module 38 receive and output voice data. The voice reception module 36 transmits received voice signals to the first wireless communication unit 16 through the voice processing module 46, while the voice output module 38 receives voice signals from the first wireless communication unit 16. The keypad module 44 includes a plurality of keypads, utilized for receiving signals from users and generating corresponding control commands to the first wireless communication unit 16. The speech identification module 48 is utilized for initially identifying speech, and generating corresponding control commands to the first wireless communication unit 16. The control commands can be a part of speech sounds with appropriate lengths. High-level speech identification can be performed in the base end or other units.

Preferably, the first wireless communication unit 16 exchanges signals with the second wireless communication unit 22 through full-duplex wireless communication. The network unit 24 can transmit signals to other electronic devices, such as computers, mobile phones, and then to the extranet 28. The extranet 28 can be xDSL, cable, or fiber network systems.

In summary, the embodiment of the present invention integrates a communication device and the electronic device into a telephone system, so that the user can wirelessly make a phone call or remotely control the electronic device. Therefore, the user is free from limitation of telephone wire, and the quality of life can be promoted.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A telephone system integrated with an electronic device comprising:
a mobile end comprising:
a phone unit for generating voice data;
a remote control unit for generating a control signal; and
a first wireless communication unit coupled to the phone unit and the remote control unit, for wirelessly transmitting the voice data and a control command according to the control signal; and
a base end comprising:
a second wireless communication unit for wirelessly receiving the voice data;
a network unit coupled to the second wireless communication unit, for transmitting packets of the voice data through a network for establishing a communication connection between the phone unit and a destination; and
a control unit coupled to the second wireless communication unit, for receiving the control command outputted from the first wireless communication unit through the second wireless communication unit for controlling the electronic device.

2. The telephone system of claim 1, wherein the phone unit comprises:
a voice reception module for receiving a first voice signal for generating the voice data;
a voice output module for outputting a second voice signal; and
a signal processing module coupled to the voice reception module, comprising a speech identification module for receiving identification data of a receiver through the voice reception module, and wirelessly transmitting the identification data of the receiver to the second wireless communication unit through the first wireless communication unit, for demanding the communication connection between the phone unit and the destination.

3. The telephone system of claim 1, wherein the remote control unit comprises a plurality of keypads for generating the control signal.

4. The telephone system of claim 2, wherein the signal processing module comprises the speech identification module for generating voice command data by speech identification according to the voice data generated by the voice reception module, and for wirelessly outputting the voice command data for controlling the electronic device and a command module coupled to the speech identification module and a keypad module through the first wireless communication unit, for wirelessly outputting a command signal generated by the keypad module through the first wireless communication unit for controlling the electronic device.

5. The telephone system of claim 1, wherein the first wireless communication unit and the second wireless communication unit transmit the voice data through full-duplex wireless communication.

6. A mobile end of a telephone system integrated with an electronic device, comprising:
a phone unit for generating analog voice data;
a remote control unit for generating a control signal; and
a wireless communication unit coupled to the phone unit and the remote control unit, for wirelessly transmitting the analog voice data and a control command for controlling the electronic device according to the control signal.

7. The mobile end of claim 6, wherein the phone unit comprises:
a voice reception module for receiving a first voice signal for generating the voice data;
a voice output module for outputting a second voice signal; and
a signal processing module coupled to the voice reception module, comprising a speech identification module for receiving identification data of a receiver through the voice reception module, and wirelessly outputting the identification data of the receiver through the wireless communication unit, for demanding a communication connection between the phone unit and the destination.

8. The mobile end of claim 6, wherein the remote control unit comprises a plurality of keypads for generating the control signal.

9. The mobile end of claim 7, wherein the signal processing module comprises the speech identification module for generating voice command data by speech identification according to the voice data generated by the voice reception module, and for wirelessly outputting the voice command data for controlling the electronic device and a command module coupled to the speech identification module and a keypad module through the wireless communication unit, for wirelessly outputting a command signal generated by the keypad module through the wireless communication unit for controlling the electronic device.

10. The mobile end of claim 6, wherein the wireless communication unit exchanges signals through full-duplex wireless communication.

11. A base end of a telephone system integrated with an electronic device, comprising:
a network unit for transmitting voice data through a network;
a wireless communication unit coupled to the network unit for wirelessly receiving the voice data; and
a control unit coupled to the wireless communication unit, for receiving a control command through the wireless communication unit for controlling the electronic device.

12. The base end of claim 11, wherein the wireless communication unit exchanges signals through full-duplex wireless communication.
